(19) United States
(12) Patent Application Publication
(10) Pub. No.: US 2012/0245723 A1
(43) Pub. Date: Sep. 27, 2012

(54) PREFERENCE ENGINE DRIVEN PERSONALIZED MUSIC SERVICE

(76) Inventor: Thomas Edward Horlander, Indianapolis, IN (US)

(21) Appl. No.: 13/514,640

(22) PCT Filed: Dec. 18, 2009
(86) PCT No.: PCT/US09/06651

§ 371 Date: Jun. 8, 2012

(51) Int. Cl. G06F 17/00

(52) U.S. Cl. 700/94

(57) ABSTRACT

The disclosed methods and systems provide for a preference engine driven personalized music service that can be implemented in consumer electronic device, such as set top box, that is capable of receiving a digital broadcast stream containing music. The personalized music service described herein does not require the consumer electronic device to have two-way communication. The necessary processing can be done on the device itself removing the need to transmit information to a remote server for processing. The method involves receiving a digital broadcast stream containing music. One or more songs are then selected from the digital broadcast stream based on a music preference for a user. The one or more selected songs can then be assembled into a custom station.

### BACKGROUND OF THE INVENTION

1. Technical Field

This invention relates to the field of personalized music services. More particularly, this invention relates to personalized music stations assembled from a digital broadcast stream.

2. Description of Related Art

There are personalized music services, wherein a user indicates a musical preference and is provided with songs matching the indicated musical preference. One example of such a personalized music service is Pandora (Pandora is a registered trademark of Pandora Media, Inc., Oakland, Calif.). With Pandora, a user provides a music selection, such as an artist or a song, on a client device; the client device then submits the music selection to a server which has access to a music database. The service searches the database for music that matches the music selection and then provides a stream of music matching the music selection back to the client device for the enjoyment of the user. The user can be given the option of voting “thumbs up” or “thumbs down” for a given song being streamed. This information can then be used to refine the music selection for the stream.

Since the database and processing are located on a remote server, the size of the database and available music as well as the processing used to search and determine musical matches can be very robust. However, locating the music and processing on a remote server also means that two-way communication is required between the client device where the initial music selection is made and the streamed music is received, and the server where the music and processing is located. This means devices that possess only one-way or limited two-way communication capabilities cannot make use of such conventional client-server based streaming music service. For example, many satellite receivers, personal video recorders (PVRs), or digital television receivers do not have or make use of such two-way communication. Although many satellite receivers, DVRs, or digital television receivers can have the capability of two way communication, many are never connected or configured as it is not necessary for their operation.

Thus it would be beneficial to provide the functionality of such personalized music services to such devices without requiring the need for two-way communication.

### SUMMARY OF THE INVENTION

In accordance with one embodiment, a method is provided for creating a preference based music station. Preferably, such a preference based music station does not require client-server two-way communication. The method involves receiving a digital broadcast stream containing music. One or more songs are then selected from the digital broadcast stream based on a music preference for a user. The one or more selected songs can then be assembled into a custom station.

With this methodology the processing, including the selection and assembly of the music, is performed on the client device. Thus, there is no need to pass information regarding the music selection to a server, requiring two-way communication with the server.

In accordance with another embodiment, a system is provided for creating a preference based music station. The system involves a receiver, a processor, storage and an output interface. The receiver is configured to receive a digital broadcast stream containing music. The processor is configured to select songs from the digital broadcast stream based on a music preference for a user and assemble the selected songs into a custom channel. The storage is used to store the selected songs from the digital broadcast stream. The output interface is configured to output an assembled custom channel featuring the selected songs.

### BRIEF DESCRIPTION OF THE DRAWINGS

FIG. 1 is a diagram depicting an environment in which a personalized music service can be used.

FIG. 2 is a block diagram useful depicting the elements of a system in accordance with one embodiment.

FIG. 3 is a flow diagram illustrating a methodology in accordance with on embodiment.

FIG. 4 is a flow diagram illustrating additional steps of a methodology in accordance with an embodiment.

FIG. 5 is a flow diagram illustrating additional steps of a methodology in accordance with another embodiment.

### DETAILED DESCRIPTION

The methodologies, systems and teachings disclosed herein can be embodied in or as a preference engine driven personalized music service that can be implemented in a consumer electronic device, such as set top box that is capable of receiving a digital broadcast stream containing music. The personalized music service described herein does not require the consumer electronic device to have two-way communication. The necessary processing can be done on the device itself, eliminating the need to transmit information to a remote server for processing.

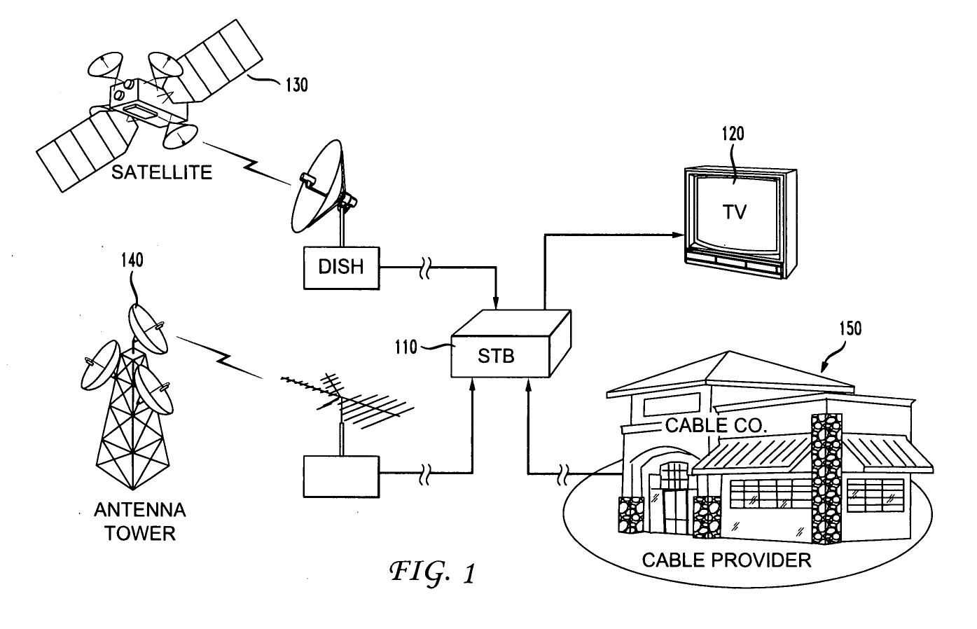

FIG. 1 depicts an environment 100 in which the preference engine based personal music service described herein can be employed. At its heart is a consumer electronics device 110. In this embodiment, the consumer electronic device is a set top box (STB) that is connected to a user's display device and/or audio system 120. The STB 110 is configured to receive a digital broadcast stream from one or more sources 130, 140, 150. For example the STB 110 can be part of a satellite system that employs a satellite dish 132 to receive a digital broadcast stream from a satellite 130. In another embodiment, the STB 110 can be a digital television or radio receiver that employs an antenna to receive a digital broadcast stream from a digital broadcasting tower 140. In yet another embodiment, the STB 110 can be connected to a cable system that provides a digital broadcast stream from a cable company 150. In certain embodiments, the STB 110 can be configured to receive digital broadcast streams from any combination of sources 130, 140, 150. It should be understood that these sources of digital broadcast streams are merely illustrative; other possible sources for digital broadcast streams will be apparent to one skilled in the art given the benefit of this disclosure.

One thing in common with the sources 130, 140, 150 depicted in FIG. 1, is that they are conventionally one-way digital broadcast technologies. That is, the satellite 130, digital broadcast tower 140, and cable provider 150 transmit digital broadcast streams without receiving any input from the consumer electronic device 110. Most STBs 110 are capable of receiving digital broadcast streams from these sources 130, 140, 150 without needing to communicate back to the source 130, 140, 150. This is different, for example, from interne communications, in which information is not sent from the source until a request for the information is received from the consumer electronic device 110. One advantage of the personalized music service set forth herein is that it does not need two-way communication. The methods, systems and teaching herein can be used in systems that only use one-way digital broadcast technologies.

The digital broadcast streams include the channels or stations provided by the satellite, television, radio, or cable provider. The channels or stations provided, depending on the provider, can include television and movie content channels, music channels, and information regarding the content of the channels digital broadcast. For example, many cable and satellite providers include both traditional television channels (CBS, HBO, TBS, etc.) as well music channels based on style or genre (classic rock, opera, heavy metal, etc.). These music channels have songs within the style or genre of the channel playing on them and can also include static images providing song information (song title, artist, album, trivia, etc.). It is this type of music content included in the digital broadcast streams that allow for the functionality of the teaching set forth in this disclosure.

In the embodiment of FIG. 1, the consumer electronics device 110 is a set top box designed to be connected to a user's display device and audio system 120 such as a television and stereo system for outputting content from a received digital broadcast stream. However, in other embodiments, the consumer electronics device 110 can be a stand-alone device that includes its own video and audio reproduction capabilities, which does not need to be connected to a user's display device and/or audio system 120. Other possible embodiments will be apparent to one skilled in the art given the benefit of this disclosure.

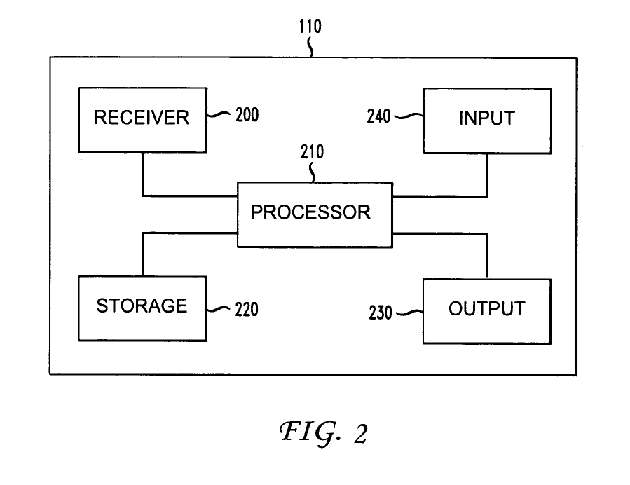

FIG. 2 is a block diagram depicting the elements of consumer electronics device 110 in accordance with one embodiment. In this embodiment, the consumer electronic device comprises a receiver 200, a processor 210, storage 220, and an output interface 230. In some embodiments, the consumer electronics device can further include an input interface 240. Each of these elements will be discussed in more detail below.

The receiver 200 is configured to receive a digital broadcast stream containing music. As discussed previously, the music can be provided on music channels that are part of the digital broadcast stream. The type and configuration of the receiver depends on the source of the digital broadcast stream. As such, the receiver can be configured to receive satellite digital broadcasts, over-the-air digital broadcasts, cable digital broadcasts or any combination thereof. The receiver allows the consumer electronic device 110 to access and decode the various channels or stations that are provided as part of the digital broadcast stream. As such, the receiver can contain one or more tuners to tune in or otherwise decode the various channels or stations that are provided as part of the digital broadcast stream. In the case of multiple tuners, the tuners can be for tuning in multiple different channels or station of the same digital broadcast stream, or different channels or station of different multiple digital broadcast streams received.

The processor 210 controls the operation of the consumer electronics device 110. The processor runs the software that operates the consumer electronics device 110 as well as provides the functionality of the personalized music service of this disclosure. This includes receiving music preferences for a user, selecting songs from the digital broadcast stream based on the music preference, and assembling the selected songs into a custom channel for a user's enjoyment. The processor 210 is connected to the receiver 200, storage 220, output interface 230, and, in some embodiments, input interface 240, and handles the transfer and processing of information between these elements. The processor 210 can be general processor or a processor dedicated for a specific functionality. In certain embodiments there can be multiple processors.

The storage 220 is where the software and other information used by the consumer electronics device are stored. The storage 220 can include volatile memory (RAM), non-volatile memory (EEPROM), magnetic media (hard drive), optical media (CD/DVD-Rom), or flash based storage. In the embodiment where the consumer electronic device 110 is a STB, such as a satellite receiver, the storage 220 will typically include memory as well as large capacity storage such as a hard-drive. The hard drive is where the selected songs of the custom station are stored.

The output interface 230 is configured to provide the content of the digital broadcast stream in the correct format for outputting on a video display or audio device. This content can include the assembled custom station provided as part of the personalized music service of this disclosure. The proper format can include the codec for the content to be output as well as the connector type used to connect to an external video display device or audio device or in some embodiments, the onboard display or speakers. The output interface 230 can also provide the graphics and menus used to indicate the content, and information about the content, available on the consumer electronic device 110.

In some embodiments the consumer electronic device 110 can further include an input interface 240. The user interface 240 allows the user to interact with the consumer electronic device 110. The input interface 240 allows information, such as a user's musical preference, to be provided to the consumer electronic device 110. The user interface 240 also allows for the selection of content available on the consumer electronic device 110. The user interface 240 can also handle the interfacing with the various devices that can be used to input information, such a remotes, keyboards, etc.

It should be understood that the elements set forth in FIG. 2 are illustrative. The consumer electronic device 110 can include any number of elements and certain elements can provide part or all of the functionality of other elements. For example, much of the functionality of the receiver 200, output interface 230, and input interface can be performed by the processor 210 or multiple general or dedicated processors. Other possible implementations will be apparent to one skilled in the art given the benefit of this disclosure.

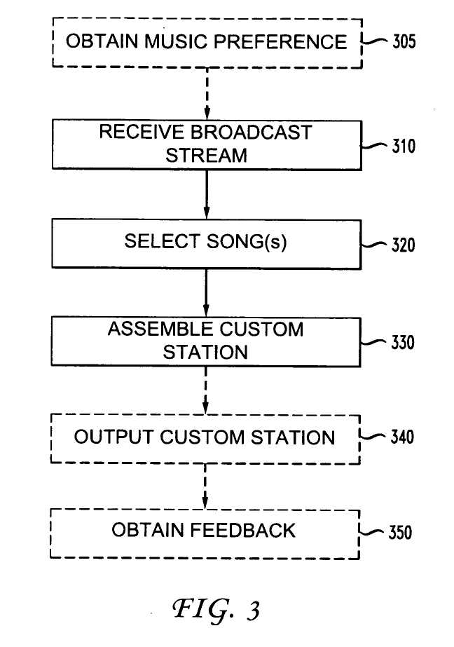

FIG. 3 is a flow diagram depicting a method 300 for providing a personalized music service in accordance with one embodiment. At its most basic, the method involves three steps. The first step is receiving a digital broadcast stream containing music (step 310). One or more songs are then selected from the digital broadcast stream based on a music preference of a user (step 320). Finally, the selected songs are assembled into a custom station (step 330). In certain embodiments, the method can include additional steps such as obtaining a music preference for a user (step 305), outputting the custom station (step 340) and obtaining feedback on the music selection of custom station (step 350). Each of these steps will be discussed in more detail below.

Step 305 involves obtaining a music preference for a user. It is from this music preference that the personalized music service is based. The music preference can be as broad as a style or genre, or narrow as an artist or song. Similarly, preferred genre or style can be inferred from a selected song or artist, and preferred artists and songs can be inferred from a selected genre or style. In some embodiments, a music preference is inputted by the user, such as by selecting a genre, style, artist, or song. In certain such embodiments, the user can be provided with the ability to give feedback on or otherwise rate (i.e. “thumbs up/down”) songs that are playing or are part of a custom station that can be used to establish a music preference (step 350). In other embodiments, a music preference can be inferred from the listening or viewing habits of a user. As such, the music preference for the user can evolve with use. Likewise, a user may also edit the music preference to further tailor the music preference to his or her personal tastes.

In some embodiments multiple music preferences can be obtained. The multiple preferences can be for one user or multiple users. For example a single user can want to create a custom jazz station and a custom rock station, thus a music preference for jazz can be obtained and a music preference for rock can be obtained. Conversely, one user can prefer a first type of music while another user can like a different type of music, thus separate music preferences are obtained for each user.

In step 310, the digital broadcast stream containing music is received. In the case of consumer electronic device 110, such as a set top box, the device 110 is configured to receive one or more digital broadcast streams. This step can also include the decoding of the received digital broadcast stream into the various channels or stations contained in the digital broadcast stream. In the case of a satellite system, the digital broadcast stream can contain several music channels making hundreds of songs available to the receiver at any time. It is from these available songs on the provided music channels that the songs for the custom station are selected.

In the case of a satellite system, wherein the consumer electronics device is a satellite receiver, the selection of songs can operate similarly to a personal video recorder (PVR). Indeed, in satellite receivers that possess PVR functionality, this can be an extension of such functionality. That is, when not otherwise in service, one or more of the available tuners can be used to tune into music channels containing music matching a music preference for a user from which songs can be selected.

Selecting songs from the digital broadcast stream (step 320) can be performed using a preference engine. The preference engine is usually software designed to make selections based on a preference. In the present case, the selection is songs based on a music preference. Thus the preference engine attempts to select songs that match or are similar to a music preference for a user, such as songs in the same genre, style, or by the same artist. In some embodiments, the preference engine can be responsive to feedback from the user. For example, a user may be asked to provide feedback on music selected by the preference engine such as giving a “thumbs up” or “thumbs down” to music selected by the preference engine (step 350). This received feedback can then be used by the preference engine to refine the selection process. The preference engine can also use historical user information (like previous selection, or viewing habits) to refine the selection process.

In some embodiments, association databases can be employed which associate styles, genres, artists, songs with other styles, genres, artists, and songs based on popularity, recommendations, provider preferences, etc. For example, a provider can wish to spotlight a particular artist, in which a case the artist can be associated with genres, styles, artists and songs that are preferred by a target audience for the spotlighted artist. Such association databases are preferably maintained on the consumer electronic device 110, but can be initially provided and/or periodically updated by the provider 130, 140, 150 in a manner similar to an electronic program guide.

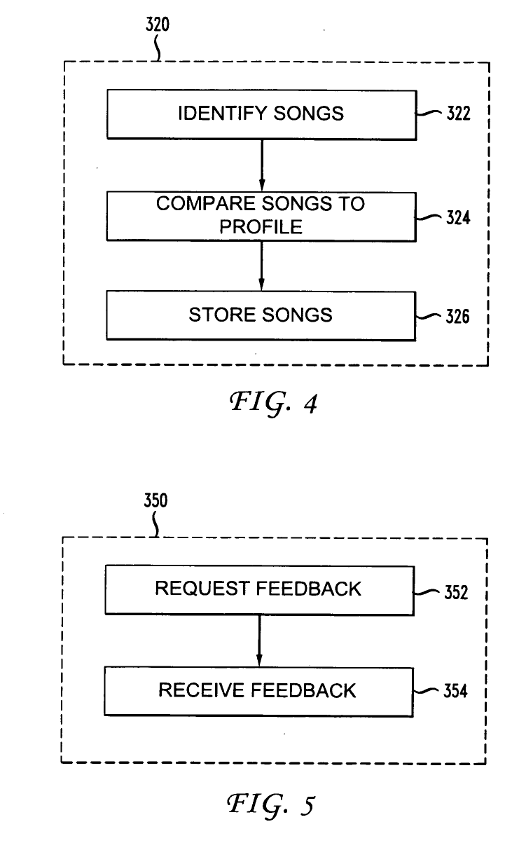

In certain embodiments, selecting one or more songs from the digital broadcast stream (step 320) can involve additional steps. An example of this can be seen in FIG. 4. In the example of FIG. 4, the step of selecting songs (320) can include identifying one or more songs in the digital broadcast stream (step 322); comparing the identified one or more songs to the music preference for the user (324); and storing the identified song(s) if the one or more songs match the music preference for the user (step 326). Each of these steps is described in more detail below.

Identifying one or more songs in the digital broadcast stream (step 322) can be performed in a number of ways. In one embodiment, information from a program guide can be used to identify songs. For example, in many satellite and cable digital broadcast streams, music channels are identified by genre (i.e. “classic rock”, “jazz”, “opera”, etc). Such stations can also have designated blocks of similar programming (i.e. theme blocks like “rock from the 60's”, etc). This information can be used to identify the type of songs in the digital broadcast. These music channels often also provide a screen accompanying the song indicating the song title, artist, and album for the song. In such cases, this information can also be used to identify the song. In other embodiments, a digital broadcast stream can include meta-data or embedded tags that identify the genre, song, artist, album or other information. In such embodiments, this information can be used to identify the song.

In another embodiment, songs from music programming on non music-only channels can also be identified for selection. For example, channels like MTV and VH1 have music programming containing songs that can match a music preference. Likewise, some channels can show operas or musicals containing songs that can match a music preference. Other techniques and methodology for identifying songs will be apparent to one skilled in the art given the benefit of this disclosure.

Once a song has been identified (step 322), the song can be compared to one or more music preferences (step 324). As discussed previously, a music preference can be broad like a style of genre, or specific like an artist or song. The identified song can be compared to see if it is the same genre or style as the music preference. For example, if the music preference is classic rock, it is determined if the identified song is also classic rock. In certain embodiments, an association database is employed to determine if the identified song matches a music preference.

If the identified song is determined to match one or more musical preferences (step 324), it can then be stored (step 326). The one or more matching identified songs are saved to or otherwise stored on the storage 220 of the consumer electronic device 110. In some embodiments other information related to the song can also be stored. For example, the genre, style, title, artist and album for a stored song can also be stored. In certain embodiments, such as when a song is part of a music video or musical performance with a video as well as music component, the video component can also be stored.

Referring again to FIG. 3, after a one or more songs have been selected based on music preference for a user (step 320), the selected songs can then be assembled into a custom station or channel (step 330). The assembled custom stations (or channel) can be “virtual” in that they are not part of the channels provided as part of the digital broadcast stream but are assembled and provided on the consumer electronic device 110. For example, the custom stations can be listed in the program guide listing available services on the consumer electronic device. A custom station can include songs matching a singular music preference or multiple music preferences. For example, there can be a custom station named “David's Music.” In other embodiments, there can be separate custom stations for each of multiple music preferences. For example, each user can have one or more custom stations.

Once the songs are assembled into custom stations (step 330), the custom station can then be output (step 340). For example, a user can select a custom station listed in a program guide for a consumer electronic device 110, and the songs of the station can be played out on the user's display device and/or audio system 120. In certain embodiments, the outputted custom station can include a video component to accompany the audio component (songs). For example, song title, artist name, and/or other information about a playing song can be displayed. In some such embodiments, links to additional information can be provided. In certain embodiments, a music video or performance can be shown with both audio and visual components.

In certain embodiments feedback can be obtained from the user (step 350) regarding the music selection in order to refine the music preference and selection of songs. An example of such a process for obtaining feedback can be seen in FIG. 5. In the example of FIG. 5, obtaining feedback comprises two steps: Requesting Feedback from a user (step 352) and receiving feedback from a user in response to the request (step 354). For example, a user may be asked to rank a song on the custom station. In response, the user inputs or otherwise provides a ranking for the song. The ranking may be general indication of approval (i.e. “thumbs up” or “thumbs down”) or a more delineated indicator (i.e. ranked on a scale of 1-5). Feedback may also be obtained for Artists, albums, styles, genres, and custom stations. In certain other embodiments, a user can rank or otherwise provide feedback without being prompted for feedback. Other implementations and embodiments for obtaining feedback will be apparent to one skilled in the art given the benefit of this disclosure. The feedback obtained can then be used in refining the music preference (step 305) and song selection (step 320) discussed above.

In other embodiments, a user can be provided with the option of storing the songs (and related information) of a custom station to an external storage device or player, for example, a personal music player, or USB storage device. In some such embodiments, a user can be required to pay for such copies on an external storage device or player.

The present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

1. A method for creating a preference based music station, the method comprising:
receiving a digital broadcast stream containing music;
selecting one or more songs contained in the digital broadcast stream based on a music preference for a user;
assembling a custom station from the one or more selected songs

2. The method of claim 1, further comprising the step of obtaining a music preference for a user.

3. The method of claim 2, wherein obtaining a music preference for a user comprises the user inputting a music preference.

4. The method of claim 2, wherein obtaining a music preference for a user comprises tracking the users usage of the set top box.

5. The method of claim 1, wherein the step of receiving a digital broadcast stream containing music further comprises decoding the digital broadcast stream containing music.

6. The method of claim 1, wherein the step of selecting music contained in the digital broadcast stream comprises:
identifying the one or more songs in the digital broadcast stream;
comparing the identified one or more songs to the music preference for the user; and
storing the identified one or more songs if the identified one or more songs matches the music preference for the user.

7. The method of claim 1, wherein selecting one or more songs contained in the digital broadcast stream is based on the music preference of multiple users.

8. The method of claim 7, wherein each of the multiple users can have a separate music preference.

9. The method claim 8, wherein a custom station is assembled for each user.

10. The method of claim 1, further comprising outputting the assembled custom station.

11. The method of claim 1, wherein the digital broadcast stream is one-directional.

12. The method of claim 1, further comprising displaying available custom channels in a user interface.

13. The method of claim 1, further comprising obtaining user feedback on selected music in the custom channel.

14. The method of claim 13, wherein the step of obtaining user feedback on selected music in the custom channel comprises:
requesting feedback from a user; and
receiving feedback from a user in response to the requesting for feedback from the user.

15. The method of claim 1, further comprising providing a user an option to purchase selected music in the custom channel.

16. A system for creating a preference based music station, the system comprising:
a receiver configured to receive a digital broadcast stream containing music;
a processor configured to select songs contained in the digital broadcast stream based on a music preference for a user and assemble the selected songs into a custom channel;
storage for storing the selected songs from the digital broadcast stream; and
an output interface configured to output an assembled custom channel;

17. The system of claim 16, wherein the system comprises a set-top box.

18. The system of claim 16, further comprising an input interface for receiving commands from a user.

19. The system of claim 18, wherein the processor is further configured to obtain user feedback on selected songs in the custom music channel.

20. The system of claim 16, wherein the processor is configured to select songs from the digital broadcast stream based on the music preference of multiple users and assemble the selected songs into one or more custom channels.
